(19) United States
(12) Patent Application Publication
(10) Pub. No.: US 2002/0157773 A1
(43) Pub. Date: Oct. 31, 2002

(54) Gravure-printed laminated packaging material production method and laminated packaging material produced by this method

(76) Inventors: Nobuyuki Kawai, Owariasahi-shi (JP); Hirotsugu Fukumori, Yokohama-shi (JP)

Correspondence Address: McGLEW AND TUTTLE, P.C., SCARBOROUGH STATION, SCARBOROUGH, NY, 10510-0827, US

(21) Appl. No.: 10/132,898

(22) Filed: Apr. 25, 2002

(30) Foreign Application Priority Data
Apr. 27, 2001 (JP) 2001-131563

(51) Int. Cl. B32B 3/00

(52) U.S. Cl. 156/244.16; 428/201; 428/204

(57) ABSTRACT

An environment friendly method of producing gravure-printed laminated packaging materials is provided enabling a reduction in a quantity of organic solvents used in printing processes. The method includes gravure printing using aquatic gravure printing inks on a gravure-printed base film and laminating an intermediate base film and/or a heat-sealable film on the gravure-printed base film with an extrusion lamination method using a polarizing resin not requiring any anchor coating agent for the lamination. An extrusion lamination method using a polarizing resin not requiring any anchor coating agent may be used for the formation of a heat-sealable resin layer.

### BACKGROUND OF THE INVENTION

1. Field of the Invention

The present invention relates to a method of producing a laminated packaging material with a base film thereof printed by the gravure printing using gravure printing inks and a laminated packaging material produced by the production method. More specifically, this invention relates to a packaging material production method capable of providing an environment-friendly gravure-printed laminated packaging material by using a processing technology requiring less organic solvent as compared to the conventional technology in the gravure printing as well as in laminating when an intermediate layer base film and/or a heat-sealable film are laminated on the gravure-printed film, or when a heat-sealable resin layer is formed on a surface of the base film or the intermediate layer base film, and to a laminated packaging material produced by the method.

2. Prior Art

Various types of laminated packaging materials are now widely used that have a printed base film with an intermediate base film and/or a heat-sealable resin layer for providing a heat-sealing capability thereto laminated thereon. This provides the functionality a gas barrier capability.

When gravure printing is performed on a base film of any of these laminated packaging materials, a gravure printing method performed with an organic solvent type of gravure ink is often employed. Further when an intermediate base film and/or heat-sealable film, or a heat-sealable resin layer are laminated on the base film, a dry lamination method performed with an organic solvent type of adhesive and/or an organic solvent type of anchor coating agent are often employed.

However, to satisfy the needs for environment protection, various methods are now being reviewed for reducing a quantity of the organic solvent used for the purposes as described above. Namely in the field of gravure printing technology, the gravure printing method using an aquatic gravure ink is now being given keen attention. The use of only an aquatic ink is inadequate for the application of the aquatic gravure printing for industrial purposes (as described hereinafter). Further the ink has its intrinsic defects (also described later) as an ink because it is aquatic, so that the gravure printing method performed with an aquatic gravure printing ink has not been established. On the other hand, in the field of lamination technology, where the resin is provided for extrusion lamination not requiring any anchor coating agent, it has been developed and is now drawing strong attentions. However, the use of a method enabling a reduction of a quantity of organic solvents either the gravure printing process or the lamination process in the laminated packaging material production method in which the gravure printing is combined with the lamination method is not adequate. The development of an environment-friendly new laminated packaging material is possible only when a method enabling the reduction of the quantity of ink used both in the gravure print process and the lamination process is provided.

### OBJECT OF THE INVENTION

The present invention was made in the circumstances as described above, and it is an object of the present invention to provide a method of producing environmentally-friendly laminated packaging materials, in which a smaller quantity of organic solvent is used in the gravure printing process as well as in the lamination process when an intermediate base material film and/or a heat-sealable film or a heat-sealable resin layer is laminated on a gravure-printed base film thereof, and to provide packaging materials especially for foods or the like produced by this production method.

### BRIEF DESCRIPTION OF THE DRAWINGS

FIG. 1 is an explanatory view showing a laminated packaging material according to a third embodiment of the present invention; and

FIG. 2 is an explanatory view showing a laminated packaging material according to a fourth embodiment of the present invention.

### BRIEF DESCRIPTION OF THE PREFERRED EMBODIMENTS

A feature of the present invention consists in use of the gravure printing method using a gravure printing ink for reducing a quantity of organic solvent used in lamination of an intermediate layer base film and a heat-sealable film on a gravure-printed base film as well as in formation of a heat-sealable resin layer on a surface of the printed base film or an intermediate layer base film as well as in use of an extrusion lamination method using a polarizing resin which neither requires application of an anchor coating agent for lamination nor for formation of a heat-sealable resin layer thereon.

When the aquatic printing ink is used in the gravure printing, if a conventional type of printing plate and a conventional type of printing method both dependent of three primary colors are employed, a laminated packaging material having desired hues cannot be obtained.

To solve the problems as described above, as the present inventor already proposed a new gravure printing method using aquatic gravure ink (Japanese Patent Application No. 2000-377177), the present invention concluded that, by combining the gravure printing method described above with an extrusion lamination method using a resin not requiring the processing with any anchor coating agent, it would be possible to obtain a laminated packaging material having desired color hues and suited to practical use.

In the new proposal described above, in the gravure printing method using an aquatic gravure printing ink, in addition to the two colors of black and white, other six colors of yellow, red, blue, orange, green, and purple, namely eight colors in all are used as primary colors for the aquatic gravure printing ink used as the basic feed ink. To obtain hues for orange, green, and purple only with the three primary colors of yellow, red, and blue in addition to the two colors of black and white, yellow and red colors, yellow and blue colors, and red and blue colors are used in combination respectively, but the obtained hues are rather dirty, and particular hues that may be required by a client cannot be obtained, but with the new proposal above, when orange and yellow or red, green and yellow or blue, and purple and red or blue colors are selectively used in combination to obtain hues for orange, green, and purple colors respectively, the hues are not dirty, and particular clear hues required by a client can be obtained.

Configuration of a printing plate used for printing is another important factor when the aquatic gravure ink is used. Namely, when an aquatic printing ink is used for printing, if the printing plate to be used is a conventional one (a low mesh with about 175 lines and a deep plate with the depth of 18 to 30μ), as the aquatic gravure printing ink is hardly dried due to its intrinsic defect, the printing speed becomes lower, and in addition, dots on a printed material are not clear (with the low reproducibility of dots), which makes it impossible to obtain desired hues, and in addition, when gravure printing ink is used, such troubles as clogging of the plate, crossing-over thereon, doctor lines, and contamination of a printing drum often occur due to the low re-solubility into water or/alcoholic solvent, and a printed material with desired quality can hardly be obtained partially because of these troubles. On the other hand, with the new proposals, not a deep printing plate but a shallow printing plate with the total line number in the range from 200 to 400 lines, preferably 350 lines and also with the depth in the range from 10 to 17μ, preferably in the range from 12 to 13μ is used, so that all of the troubles encountered in use of the conventional type of printing plate as described above never occur. This is true for any type of printing plate. When the number of lines is smaller than 200, dots on the printing ink film are fuzzy as the aquatic ink does not dry fast, which makes it difficult to obtain desired hues, and on the contrary, when the number of lines is larger than 400, a bank surrounding a cell on a gravure printing plate (intaglio plate) is cut, and a dot on aquatic ink film is not formed, or a dot becomes smaller, so that the color tone width becomes narrower and desired hues cannot be obtained.

When the plate depth is 17μ or more, because of the hardness of aquatic ink in resolving in an aqueous solution due to an intrinsic defect of the aquatic ink, such troubles as clogging of a printing plate, crossing-over thereon, doctor lines, and contamination of a printing drum occur. Further due to the hardness of aquatic printing ink in drying, not only the printing speed becomes lower, but also dots on a printed material become fuzzy, which makes it difficult to obtain desired hues. When the depth of engraving on a printing plate is 10μ or less, unevenness is generated on a surface of the printing plate with varies hues and the ink film is thin, so that desired color density can hardly be obtained.

Another important thing for obtaining desired hues with the printing plate as described above is the use of the printing method of overprinting one color after another within the eight colors (process colors) described above, using the printing plate having a different dot percentage for each color. When printing is performed with the conventional type of oily gravure printing inks in combination, the inks are quickly dried, so that dots on a printed material are not clear and the hues vary to a disadvantageous level, and to overcome these troubles, generally the feed inks are previously kneaded well to form an ink having a particular color, and printing is performed with the particular color ink. In contrast, when an aquatic printing ink is used for printing, the circumstances are completely different, and as the problem in printing with an aquatic printing ink having a particular color is the low re-solubility of the aquatic ink into a solvent, which is an intrinsic defect of the aquatic ink, and therefore it is difficult to use the ink having a particular color again and again, and it is required to prepared an ink having a desired color each time printing is performed, which is a serious defect of an aquatic printing ink from the economical point of view.

On the other hand, the new proposal described above makes it possible to combine the use of the six primary colors described above in addition to the two colors of black and white, using the printing plate as described above, and using the printing method by overprinting one color after another within the primary colors described above, and with this combination, reproducibility of dots on a printed material are excellent and are far better than that provided when oily gravure printing inks are used. As such, hue control that satisfies one's customers' demands is possible without mixing any special ink having a particular color. In other words, in the hue control technique for printing with a gravure printing plate (intaglio plate), a value obtained by measuring a ratio of an area of cells surrounded by banks against a unit area on the plate with a dot meter is called dot percentage, and when gravure printing with aquatic inks is performed using a printing plate with varied dot percentages for different colors respectively, dots each having a desired size (area) can be obtained with inks satisfying the dot percentages required for different printing plates and the reproducibility is far superior, indeed excellent as compared to that provided when oil based inks are used.

Therefore, to obtain a hue that satisfies the customer's demands, printing may be performed by selectively using, for overprinting, printing plates each having a different dot percentage for orange and yellow or red colors for orange, those for green and yellow or blue colors for green, or those for purple and red or blues for purple respectively, and in this case a visually desirable hue as a collection of different dot percentages for different colors can be obtained on a printed material.

Then, by performing gravure printing with an aquatic ink on a base film and further performing extrusion lamination using a polarizing resin for lamination not requiring any anchor coating agent when an intermediate layer base film and/or a heat-sealable film are laminated on each other, or when a heat-sealable resin layer is formed on a surface of the printing base film or the intermediate layer base film, it is possible to obtain an ideal and environment-friendly packaging material which can be put into practical use and also which enables reduction of a quantity of organic solvents used in printing.

Of the various types of lamination methods for obtaining a laminated packaging material, only the extrusion lamination method not requiring an anchor coating agent and performed by using a polarizing resin makes it possible to reduce a quantity of organic solvents used in printing and also to reduce the printing cost.

Namely, when a three-layered packaging material produced by the present production method of the invention, namely a laminated packaging material consisting of a printed base film, an intermediate layer base film having the gas barrier capability, and a heat-sealable film is compared to those produced by the various lamination methods as described above, in addition to difference in materials used for forming the three layers, there are the clear differences as described below.

At first, in the dry lamination method, a printed base film, an aquatic adhesive, an intermediate layer base film, an aquatic adhesive, and a heat-sealable film are laminated on each other. The cost for the aquatic adhesive and processing cost for lamination between the first and second layers and that for lamination between the second and third layers are required.

In the method in which both the dry lamination and extrusion lamination are employed, a printed base film, and aquatic adhesive, an intermediate layer base film, an aquatic anchor coating agent, an extrusion agent, and a heat-sealable film, or a printed base film, an aquatic adhesive, an intermediate layer base film, an aquatic anchor coating agent, and a heat-sealable extrusion resin, are laminated on each other. The cost for the aquatic adhesive, aquatic anchor coating agent, and extrusion resin and processing cost for the dry and extrusion processes are required.

In the method in which both the dry lamination performed without using any solvent and the extrusion lamination are employed, a printed base film, a solvent-free adhesive layer, an intermediate layer base film, an aquatic anchor coating layer, an extrusion resin layer, and a heat-sealable film, or a printed base film, a solvent-free adhesive, an intermediate layer base film, an aquatic anchor coating agent, an extrusion resin, and a heat-sealable film, or printed base film, a solvent-free adhesive, an intermediate layer base film, an aqueous anchor coating agent, heat-sealable extrusion resin layer are laminated on each other, so that, in addition to the cost for the solvent-free adhesive, aquatic anchor coating agent, and extrusion resin, also the cost for dry and extrusion processing is required.

In the extrusion lamination method, a printed base film, an aquatic anchor coating agent, an extrusion resin, an intermediate base film, an aquatic anchor coating agent, an extrusion resin, and a heat-sealable film, or a printed base film, an aquatic anchor coating agent, an extrusion resin, an intermediate layer base film, an aquatic anchor coating agent, and a heat-sealable extrusion resin layer are laminated on each other. Although the cost for the aquatic anchor coating agent and extrusion resin is required, the required processing cost is only for one inline process, and because of this feature, the cost is lower as compared to any of those required for the lamination methods described above.

In contrast, with the present invention, a base film printed with an aquatic gravure printing ink, an extrusion resin, an intermediate layer base film, an extrusion resin, and a heat-sealable film, or a base film printed with an aquatic gravure printing ink, an extrusion resin, an intermediate layer base film, and a heat-sealable extrusion resin layer are laminated on each other, so that only the cost for extrusion resin and the processing cost for only one inline process are required. Because of this feature, the cost is lowest of all the lamination methods described above.

Although no comment was made on materials cost for the aquatic adhesive, aquatic anchor coating agent, solvent-free adhesive, and extrusion resin, the depth of the extrusion resin layer can be made smaller according to the necessity, the present invention is more advantageous as compared to the lamination methods based on the conventional technology also in this point.

A film for providing the functionality such as the gas barrier capability or light shielding capability may be used as the intermediate layer base film. Two or more types of such films may be used in combination. However, there is no specific limitation over configuration of the intermediate layer base film.

As the resin for lamination (extrusion resin) does not require any anchor coating agent, for instance, a copolymer-based resin such as ethylene-(meta) acrylate, or a polyolefin-based resin such as low density polyethylene or linear low density polyethylene denatured with a polarizing agent such as unsaturated calboxylic acid may be used. However, there is no specific limitation as to the composition of the extrusion resin.

### EXAMPLE 1

Using a bi-axial oriented polypropylene film 20μ and printing inks for six primary colors of yellow, red, blue, orange, green, and purple each with the printing viscosity of Zahn cup number #3-16 sec prepared by using an aquatic gravure printing ink available from the market (produced by Toyo Ink Kabushiki Kaisha, Aqua-Echol JW22) and a diluted solvent in which water, ethanol, and isopropyl are mixed at the ratio of 50/30/20% (produced by Tokyo Ink Seizo Kabushiki Kaisha: AQ 602F), and also preparing with a laser a printing plate with 350 lines and the plate depth of 13μ as a gravure printing plate, a printed material was obtained by using, for overprinting, printing plates for orange and yellow or orange and red colors for orange, those for green and yellow or green and blue colors for green, or those for purple and red or purple and blue colors for purple respectively.

### COMPARATIVE EXAMPLE 1

Using an aquatic printing inks available from the market for the three primary colors of yellow, red, and blue, a printed material was obtained by using aquatic printing inks for the three primary colors of yellow, red, and blue available from the market and by using printing plates for red and yellow colors for orange, those for yellow and blue colors for green, and those for red and blue colors for purple respectively.

In Example 1, a printed material with desired clean hues could be obtained, but in Comparative Example 1, all of orange, green, and purple colors were dirty, and desired clear hues could not be obtained.

### EXAMPLE 2

Using a bi-axial oriented polypropylene film 20μ and printing inks for six primary colors of yellow, red, blue, orange, green, and purple as well as two colors of black and white each with the printing viscosity of Zahn cup #3-16 see prepared by using an aquatic gravure printing ink available from the market (produced by Toyo Ink Kabushiki Kaisha, Aqua-Echol JW22) and a diluted solvent in which water, ethanol, and isopropyl alcohol are mixed at the ratio of 50/30/20% (produced by Tokyo Ink Seizo Kabushiki Kaisha: AQ 602F), and further preparing with a laser a printing plate with 350 lines and the plate depth of 13μ as a gravure printing plate, a printed material was obtained by using, for overprinting, 8 printing plates for 8 colors prepared as described above.

### COMPARATIVE EXAMPLE 2

Printing plates each with 175 lines and plate depth of 18μ for gravure printing with oily (oil based) printing inks were prepared with a laser, and a printed material was obtained by performing printing in the same method as that employed in Example 2 above.

In Comparative Example 2, the printing speed was lower (70 m/min) due to the difficulty of drying, which is an intrinsic defect of an aquatic ink, and further dots on the printed material were not clear. Further the printed material did not have a desired quality because of such difficulties as clogging of the printing plates, crossing-over thereon, doctor lines, and contamination of the printing drum occurred due to the poor re-solubility of the aquatic inks, which is one of the intrinsic defects of an aquatic ink. In contrast, with the method employed in Example 2, the printing speed was improved to 130 m/min, and further the reproducibility of dots on the printed material was far more excellent as that in Comparative Example 2.

### EXAMPLE 3

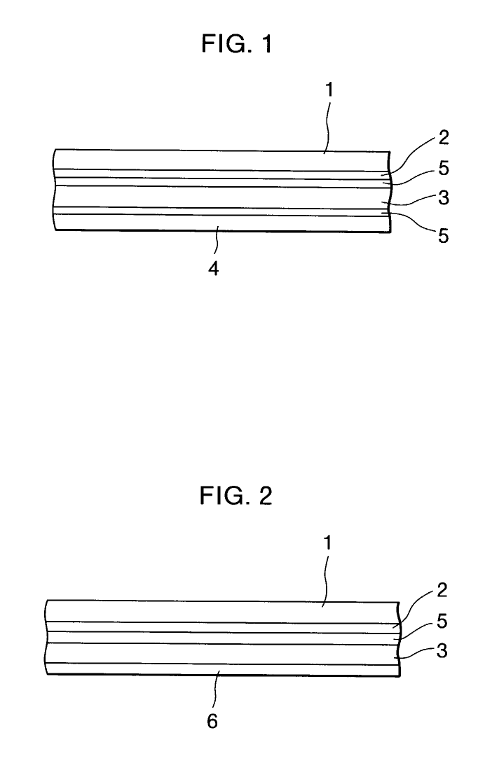

To obtain a laminated packaging material for snacks, printing 2 was performed with aquatic printing inks to a base film 1 comprising a bi-axial oriented polypropylene film (20μ) in the same method as that employed in Example 2 as shown in FIG. 1. Further an intermediate layer base film 3 comprising a polyester film (12μ) with aluminum deposited thereon for giving the gas barrier capability and a heat-sealable film 4 comprising a not-stretched polypropylene film (20μ) were laminated on the base film 1 by performing inline extrusion lamination with a polarizing resin (produced by Mitsui/Dupont Polychemical Kabushiki Kaisha; Nuclear AN 4228C) (10μ) as a resin 5 for lamination not requiring any anchor coating agent due to polarizing.

### COMPARATIVE EXAMPLE 3

A butadiene-based or alcoholic solvent-based anchor coating agent available from the market was applied to the base film with the depth of 20μ prepared in Example 3 by the conventional extrusion lamination method, and then the intermediate layer base film with the depth of 12μ used in Example 3 was laminated thereon by using a low density polyethylene resin with the depth of 15μ as a resin for lamination. Then a urethane-based or ethyl acetate solvent-based anchor coating agent was applied inline to the laminated film described above, and further the heat-sealable film 4 described above was laminated by extruding a low density polyethylene resin with the depth of 15μ.

As a result, the laminated packing material prepared in Example 3 above had the same or similar physical properties as those of conventional materials, and in addition, such advantages as reduction of a quantity of organic solvents used in a printing process, smaller depth, and cost reduction were provided.

### EXAMPLE 4

To obtain a laminated packaging material for powder soup, gravure printing 2 was performed on a base film 1 comprising a bi-axial oriented polyester film (12μ) with aquatic printing inks used in Eample 2 as shown in FIG. 2. A polarizing resin 5 (which was the same as that used in Example 3) (10μ) was used as a resin 5 for lamination not requiring any anchor coating agent to laminate an intermediate layer base film 3 comprising aluminum foil (7μ) for providing a gas barrier capability thereon. Then a polarizing resin (produced by Mitsui/Dupont Polychemical Kabushiki Kaisha; Nuclear AN 4225C) (20μ) was extruded inline for lamination to form a heat-sealable resin layer 6.

### COMPARATIVE EXAMPLE 4

A butadiene-based or alcoholic solvent-based anchor coating agent available from the market was applied to the same base film as that in Example 4 by the conventional extrusion lamination method, and a low density polyethylene resin with the depth of 15μ was extruded to laminate the intermediate layer base film with the depth of 7μ thereon. Then a low density polyethylene resin with the depth of 20μ was extruded inline to form a heat-sealable resin layer thereon.

As a result, the laminated packaging material provided in Example 4 had the same or similar physical properties and heat sealing capability as those of laminated packaging materials based on the conventional technology. In addition the advantages related to the reduction of the quantity of organic solvents used in a printing process, smaller depth, and cost reduction were provided.

### ADVANTAGES

As described above, the present invention can provide an established and consistent technology in the field of laminated packaging materials satisfying the requirements in the gravure printing as well as in the lamination technology and also required for satisfying the needs for environment protection and reduction in a quantity of organic solvent used in the printing process, and the technology provided by the present invention has far more excellent cost performance as compared to that provided by other technologies.

Thus, with the present invention, it is possible to solve the problems such as undesirable environmental conditions for workers caused by organic solvents in printing plants or lamination plants, disasters, air pollution, health problems caused by solvents remaining in packaging materials for foods products, and expensive cost for environment protection, and the merit is quite large.

What is claimed is:

1. An environment friendly method of producing gravure-printed laminated packaging materials enabling reduction in a quantity of organic solvents used in printing processes, the method comprising: gravure printing using aquatic gravure printing inks on a gravure-printed base film; and laminating an intermediate base film and/or a heat-sealable film on the gravure-printed base film with an extrusion lamination method using a polarizing resin not requiring any anchor coating agent for the lamination.

2. The gravure-printed laminated packaging material production method according to claim 1, wherein aquatic printing inks for six primary colors of yellow, red, blue, orange, green, and purple in addition to the two colors of black and white are used as basic feed inks in the gravure printing performed with aquatic gravure printing inks, printing plates each with 200 to 400 lines and plate depth in the range from 10 to 17μ are used, and colors obtained by mixing printing inks for the six primary colors described above and two colors of black and white according to the necessity (for reprinting) are used to obtain desired hues in printing.

3. A method of producing a gravure-printed laminated packaging materials each comprising a gravure-printed base film, an intermediate layer base film laminated on the base film, and a heat-sealable resin layer formed on a surface of the base film or the intermediate layer base film, the method comprising: employing a gravure printing method using aquatic gravure printing inks for the gravure printing process and employing an extrusion lamination method using a polarizing resin not requiring any anchor coating agent for the lamination process, and employing an extrusion lamination method using a polarizing resin not requiring application of an anchor coating agent for formation of the heat-sealable resin layer.

4. The gravure-printed laminated packaging material production method according to claim 3, wherein aquatic printing inks for six primary colors of yellow, red, blue, orange, green, and purple in addition to the two colors of black and white are used as basic feed inks in the gravure printing performed with aquatic gravure printing inks, printing plates each with 200 to 400 lines and plate depth in the range from 10 to 17μ are used, and colors obtained by overprinting one color after another with said six-primary colors and two colors of black and white to obtain desired hues in printing.

5. A gravure-printed laminated packaging material comprising: a base film gravure-printed with aquatic gravure printing inks; and a polarizing resin layer formed by an extrusion lamination method as a resin layer for lamination between the base film and the intermediate layer base film and/or heat-sealable film laminated thereon.

6. The gravure-printed laminated packaging material according to claim 5, wherein aquatic printing inks for six colors of yellow, red, blue, orange, green, and purple in addition to the two colors of black and white are used for gravure-printing the base film as basic feed printing inks; printing plates with 200 to 400 lines and plate depth in the range from 10 to 17μ are used as printing plates for printing with the feed printing inks; and further the gravure printing method is used in printing to obtain desired hues by using the six primary colors and additional two colors of black and white as a single color respectively or by overprinting one color after another.

7. A gravure-printed laminated packaging material comprising: a gravure-printed base film; an intermediate layer basic film laminated on the basic film; and a heat-sealable resin layer formed on a surface of the base film or the intermediate layer base film, wherein a gravure-printing method using aquatic gravure printing inks are used for the gravure printing process for forming the gravure-printed base film and a polarizing resin not requiring application of an anchor coating agent is used with the extrusion lamination method as the resin for lamination in the lamination process, and further a polarizing resin not requiring application of an anchor coating agent and formed by the extrusion lamination method is used for formation of the heat-sealable resin layer.

8. The gravure-printed laminated packaging material according to claim 7, wherein aquatic printing inks for six colors of yellow, red, blue, orange, green, and purple in addition to the two colors of black and white are used for gravure-printing the base film as basic feed printing inks; printing plates with 200 to 400 lines and plate depth in the range from 10 to 17μ are used as printing plates for printing with the feed printing inks; and further the gravure printing method is used in printing to obtain desired hues by using the six primary colors and additional two colors of black and white as a single color respectively or by overprinting one color after another.
